(19) United States
(12) Patent Application Publication
(10) Pub. No.: US 2013/0174278 A1
(43) Pub. Date: Jul. 4, 2013

(54) DIGITAL RIGHTS MANAGEMENT (DRM) SERVICE CONTROL METHOD, APPARATUS, AND SYSTEM

(71) Applicants: Peking University Founder Group Co., Ltd., Beijing (CN); Bejing Founder Apabi Technology Ltd., Beijing (CN); Peking University, Beijing (CN); Founder Information Industry Holdings Co., Ltd., Beijing (CN)

(72) Inventors: Xiaoyu CUI, Beijing (CN); Zhi Tang, Beijing (CN)

(73) Assignees: PEKING UNIVERSITY FOUNDER GROUP CO., LTD., Beijing (CN); FOUNDER INFORMATION INDUSTRY HOLDINGS CO., LTD., Beijing (CN); PEKING UNIVERSITY, Beijing (CN); BEIJING FOUNDER APABI TECHNOLOGY LTD., Beijing (CN)

(21) Appl. No.: 13/729,484

(22) Filed: Dec. 28, 2012

(30) Foreign Application Priority Data
Dec. 28, 2011 (CN) 201110448812.9

(51) Int. Cl. H04L 29/06

(52) U.S. Cl. CPC H04L 63/10
USPC 726/29

(57) ABSTRACT

A digital rights management service control method, including: receiving an authorization file request transmitted from a client terminal for a selected service operation; obtaining an authorization file template matching an authorization type included in the authorization file request; generating, based on the obtained authorization file template, an authorization file including digital resource feature information included in the authorization file request and rights feature information; and transmitting the generated authorization file to the client terminal.

### RELATED APPLICATIONS

This application is based upon and claims the benefit of priority from Chinese Patent Application No. 201110448812.9, filed Dec. 28, 2011, the entire contents of which are incorporated herein by reference.

### FIELD

The present invention relates to a digital rights management (DRM) service control method, apparatus, and system.

### BACKGROUND

Along with the emergences of digital publication and mobile reading industries, the scope of a large number of digital resources including electronic books, digital periodicals, digital music, network animation and comics, network games, etc., over networks have expanded explosively and expeditiously. Digital Rights Management (DRM) has become an important technology to facilitate transacting and distributing digital contents in a digital network environment.

Traditionally, DRM service objects are typically uni-mode objects. For example, a DRM service object can be oriented only to a specific service mode of a specific digital resource, such as a purchase service of an electronic book, a borrowing service of an electronic book, or a software authorization system.

FIG. 1 shows a block diagram of a traditional DRM service system 100. Referring to FIG. 1, the system 100 may include a client terminal 102, an upper layer service system 104, and a DRM service control apparatus, also known as a DRM service object 106. The DRM service object 106 further may include a certificate database 112, a communication protocol module 114, an encryption module 116, and an authorization module 118. For example, the communication protocol module 116 may interact with the client terminal 102 and the upper layer service system 104, the authorization modules 118 may grant a digital resource, and the encryption module 116 may encrypt information.

Traditionally, a user has access to a preset types of digital resources and a set of rights policies of digital resources. These digital resources and rights policies may not be modified dynamically during operation of the system. For example, a service system may be initially configured for the user to purchase electronic books, and now a borrowing service of electronic books and a subscription service of digital newspapers may need to be added in response to a demand for the services. In this situation, DRM service objects may be upgraded to accommodate new service functions. In addition, in a single operation mode, different customized DRM service objects may be created to supply different service flows. For example, a DRM service object capable of providing free sample reading, purchase, scheduled borrowing, renewed borrowing, returning and other rights functions may be required for a flow of purchasing or borrowing an electronic book, and a DRM service object capable of scheduled authorization may be required for a flow of granting software.

Traditional DRM service objects are customized for different digital services in the DRM service control process, and since traditional digital rights access control is not generic to a plurality of services, systems may need to be developed repeatedly for each different digital services in order to create DRM service objects of the different digital services and perform different digital service rights control.

### SUMMARY

According to a first aspect of the present disclosure, there is provided a digital rights management service control method, including: receiving an authorization file request transmitted from a client terminal for a selected service operation; obtaining an authorization file template matching an authorization type included in the authorization file request; generating, based on the obtained authorization file template, an authorization file including digital resource feature information included in the authorization file request and rights feature information; and transmitting the generated authorization file to the client terminal.

According to a second aspect of the present disclosure, there is provided a digital rights management service control apparatus, comprising: a communication module configured to receive an authorization file request transmitted from a client terminal for a selected service operation and to transmit a generated authorization file to the client terminal; a generic module configured to obtain an authorization file template matching an authorization type included in the authorization file request; and an authorization module, coupled to the communication module and to the generic module, configured to generate, based on the obtained authorization file template, an authorization file including digital resource feature information in the authorization file request and rights feature information.

It is to be understood that both the foregoing general description and the following detailed description are exemplary and explanatory only and are not restrictive of the invention, as claimed.

### BRIEF DESCRIPTION OF THE DRAWINGS

FIG. 1 shows a block diagram of a traditional DRM service system.

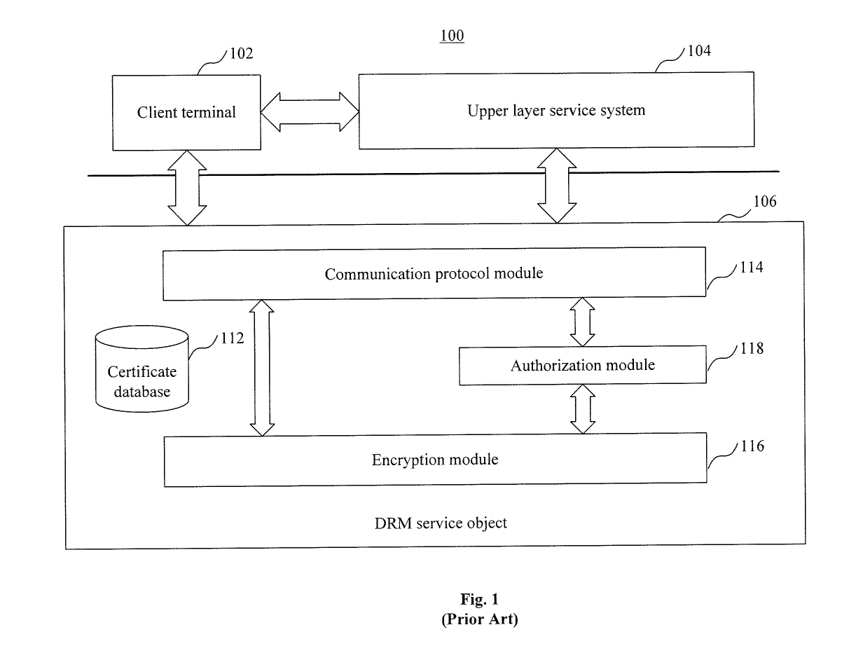

FIG. 2 shows a flowchart of a DRM service control method, according to an exemplary embodiment.

FIG. 3 shows an authorization file template configuration process, according to an exemplary embodiment.

FIG. 4 shows a flowchart of an authorization file template version matching process, according to an exemplary embodiment.

FIG. 5 shows a block diagram of a DRM service control apparatus, according to an exemplary embodiment.

FIG. 6 shows a DRM service control system, according to an exemplary embodiment.

FIG. 7 shows a flowchart of a DRM service control process, according to an exemplary embodiment.

FIG. 8 shows an authorization file template, according to an exemplary embodiment.

FIG. 9 shows a flowchart of a DRM service control process, according to an exemplary embodiment.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

In some exemplary embodiments, one or more modules disclosed in this disclosure may be implemented via one or more processors executing software programs for performing functionalities. In some embodiments, one or more of the disclosed modules are implemented via one or more hardware modules executing firmware for performing functionalities. In some embodiments, one or more of the disclosed modules include storage media for storing data, or software or firmware programs executed by the modules.

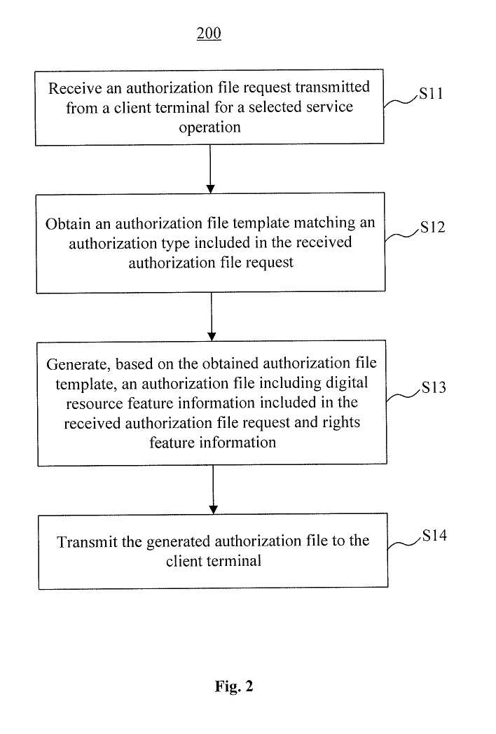

In some exemplary embodiments, there is provided a DRM service control method to provide authorization templates of corresponding DRM service control for different authorization types of different services, to thereby avoid repeated system development and maintenance. FIG. 2 shows a flowchart of a DRM service control method 200, according to an exemplary embodiment. Referring to FIG. 2, the method 200 may include the following steps.

In step S11, an authorization file request transmitted from a client terminal for a selected service operation may be received. For example, the authorization file request may be a post-purchase authorization request after a user purchases an electronic book, a request to borrow a book, etc. Thus the authorization file request transmitted from the client may include an authorization type for the request.

In step S12, an authorization file template matching with the authorization type included in the received authorization file request may be obtained. For example, it may be determined whether the authorization type included in the received authorization file request is a currently activated authorization type and, if the determination is positive, the authorization file template matching with the authorization type may be obtained. Alternatively, if the determination is negative, no corresponding authorization file template may be provided, and the process may be terminated.

In step S13, an authorization file may be generated based on the obtained authorization file template and digital resource feature information included in the received authorization file request, the authorization file including the digital resource feature information and rights feature information. For example, after the authorization file template corresponding to the requested authorization type is obtained, authorization information for a digital resource in the authorization file request may be added in the obtained authorization file template to obtain the corresponding rights feature information. The digital resource and the corresponding rights feature information may be determined from the digital resource feature information included in the authorization file request.

In the illustrated embodiment, the digital resource feature information refers to a feature and/or an attribute of the digital resource itself, for example, a unique identifier of an electronic book, a payment receipt of a purchased electronic book, equipment information on a currently used device, etc.

In the illustrated embodiment, the rights feature information refers to restricted privilege information in the authorization file, including a use rights feature, a use right restriction feature, etc.

In one exemplary embodiment, the generated authorization file further may include feature information of the authorization file, feature information of a rights issuer, feature information of a rights obtainer, integrity information of the authorization file, validity information of the authorization file, etc.

In step S14, the generated authorization file may be transmitted to the client terminal. After the generated authorization file is transmitted to the client terminal, the client terminal may determine whether the digital resource feature information and the rights feature information included in the received authorization file match. If it is determined that they match, the client terminal may perform the selected service operation. That is, the client terminal may parse the authorization file for the rights feature information to thereby obtain use authorization of the digital resource, and use the digital resource.

In addition to determining whether the digital resource feature information and the rights feature information included in the received authorization file, the client terminal may also determine whether the feature information of the authorization file, the feature information of the rights issuer, the feature information of the rights obtainer, the integrity information of the authorization file, the validity information of the authorization file, etc. match with each other. The client terminal may perform the selected service operation when all of them match.

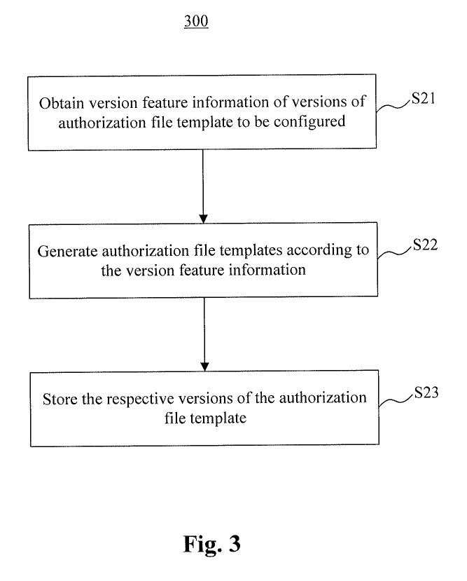

In exemplary embodiments, more than one version of an authorization file template corresponding to each authorization type may be configured for each service. FIG. 3 shows an authorization file template configuration process 300, according to an exemplary embodiment. Referring to FIG. 3, the configuration process 300 may include the following steps.

In step S21, version feature information of versions of the authorization file template to be configured may be obtained. For example, in a version management section, a DRM service control apparatus may provide a management interface via which one or more pieces of additional version feature information may be obtained.

In step S22, the respective versions of the authorization file template are generated according to the version feature information. For example, a generic module included in the DRM service control apparatus may generate different versions of the authorization template (authorization Schema templates) according to different version feature information, and may also generate corresponding communication protocol templates (communication protocol Schema templates).

In step S23, the respective versions of the authorization file template are stored. For example, the generic module stores all of the newly generated versions of the authorization template in a generic information database, such that these versions of the template may be invoked directly for use.

In exemplary embodiments, when there is more than one version of the authorization file template configured corresponding to each authorization type, it is further determined whether version information included in the authorization type in the authorization file request matches version information of the obtained authorization file template matching the authorization type, and the authorization file including the digital resource feature information and the authorization feature information may be generated if they match.

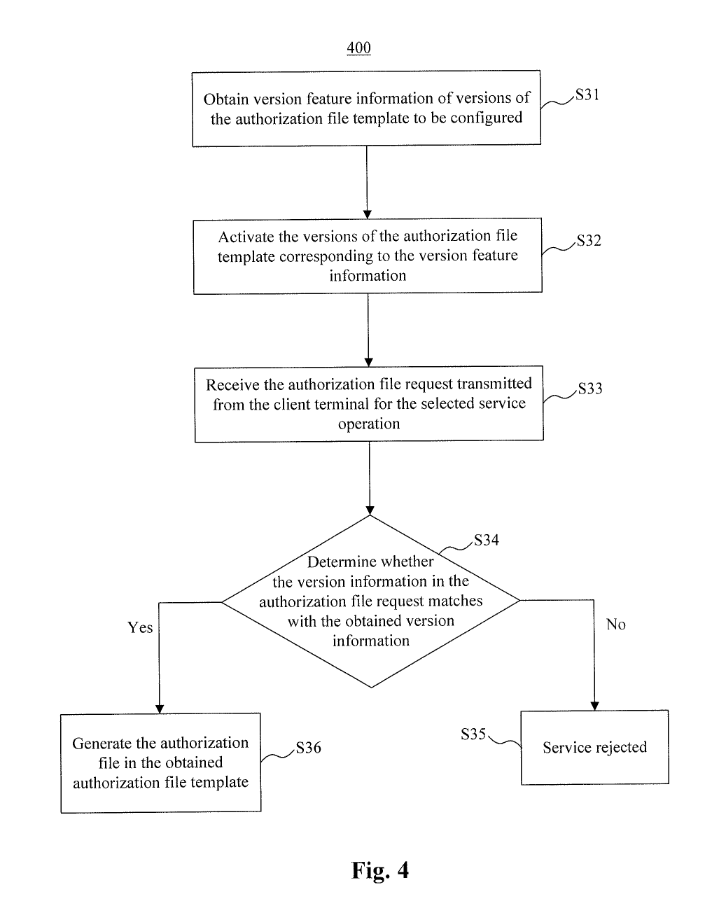

FIG. 4 shows a flowchart of an authorization file template version matching process 400, according to an exemplary embodiment. Referring to FIG. 4, the process 400 may include the following steps.

In step S31, version feature information of versions of the authorization file template to be configured may be obtained. For example, in a version management section, a DRM service control apparatus may provide a management interface via which one or more pieces of additional version feature information may be obtained.

In step S32, the versions of the authorization file template corresponding to the version feature information may be activated. For example, a plurality of versions of authorization file template may be available in a service mode, and a few or all of them may be activated.

In step S33, the authorization file request transmitted from the client terminal for the selected service operation may be received. When the client terminal requests the DRM service control apparatus, also referred to as a DRM service object, for authorization in a communication protocol of a specific version, the DRM service control apparatus may provide the authorization file request to its authorization module which runs an authorization process.

In step S34, it is determined whether the version information included in the authorization type in the authorization file request matches the version information of the obtained authorization file template matching the authorization type. For example, the authorization module first may accesses the generic module to obtain a currently activated authorization file template and determine whether version information of the currently activated authorization file template matches the version information in the authorization file request. A specific matching criterion may be set for a specific application. For example, the version information in the authorization file request may correspond to a requested version of an authorization file template requested by the user, and when this version is not higher than the currently activated authorization file template, they are considered to be matching.

When the versions match, the process goes to step S36 of generating the authorization file, as described below. Otherwise, the process goes to step S35.

In step S35, a service may be rejected. When the version information included in the authorization type in the authorization file request does not match the version information of the obtained authorization file template matching the authorization type, the authorization file request may be rejected, and corresponding error information may be returned to the client terminal.

In step S36, the authorization file may be generated in accordance with the obtained authorization file template.

When the version information included in the authorization type in the authorization file request matches the version information of the obtained authorization file template matching the authorization type, the authorization module instructs the generic module to search for a communication protocol file template and an authorization file template corresponding to the requested version. The generic module may return the authorization file template to the authorization module. The authorization module may generate an actual authorization file based on the authorization file template. Furthermore, a communication module may generate an actual communication protocol based on the protocol file template, and encapsulate the authorization file into the communication protocol. The DRM service object may return the authorization file to the client terminal based on the entity communication protocol.

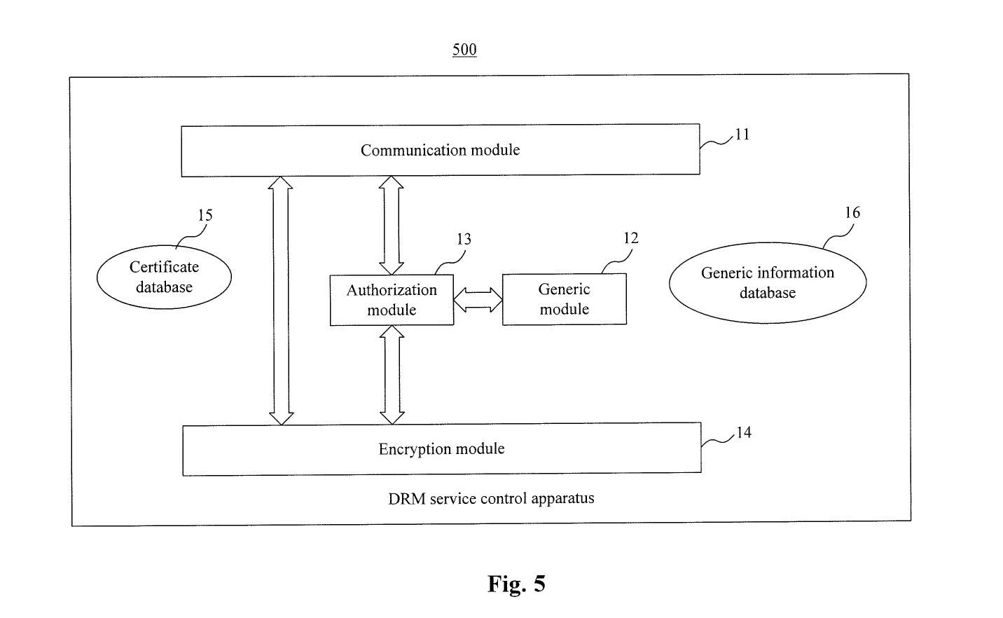

In exemplary embodiments, there is provided a DRM service control apparatus which may be included in any device for which DRM service control is requested. FIG. 5 shows a block diagram of a DRM service control apparatus 500, according to an exemplary embodiment. Referring to FIG. 5, the apparatus 500 may include a communication module 11, a generic module 12, an authorization module 13, and an encryption module 14. The apparatus 500 may further include a certificate database 15, and a generic information database 16 for storing generic information.

In exemplary embodiments, the communication module 11 may be configured to receive an authorization file request transmitted from a client terminal for a selected service operation and to transmit a generated authorization file to the client terminal. The generic module 12 may be configured to obtain an authorization file template matching an authorization type included in the authorization file request received by the communication module 11. The authorization module 13 may be configured to generate, based on the authorization file template obtained by the generic module 12, an authorization file including digital resource feature information included in the authorization file request received by the communication module 11 and rights feature information.

In exemplary embodiments, the generic module 12 is further configured to determine whether the authorization type included in the authorization file request is a currently activated authorization type, and to obtain the authorization file template matching the authorization type when the determination is positive.

In exemplary embodiments, the authorization module 13 may further be configured to, when there is more than one version of an authorization file template configured by the generic module 12 corresponding to each authorization type, determine whether version information included in the authorization type in the authorization file request matches version information of the authorization file template obtained by the generic module 12 matching the authorization type; and to generate the authorization file when they match.

In exemplary embodiments, the authorization module 13 may further be configured to verify the client terminal transmitting the authorization file request for legality based on verification information included in the authorization file request, and to instruct the generic module 12 to obtain the authorization file template after the verification is passed.

In exemplary embodiments, the encryption module 14 may be configured to encrypt information transported from the communication module 11 for secured transmission of the information. The DRM service control apparatus 500 may further include the certificate database 15 for storing various security certificates.

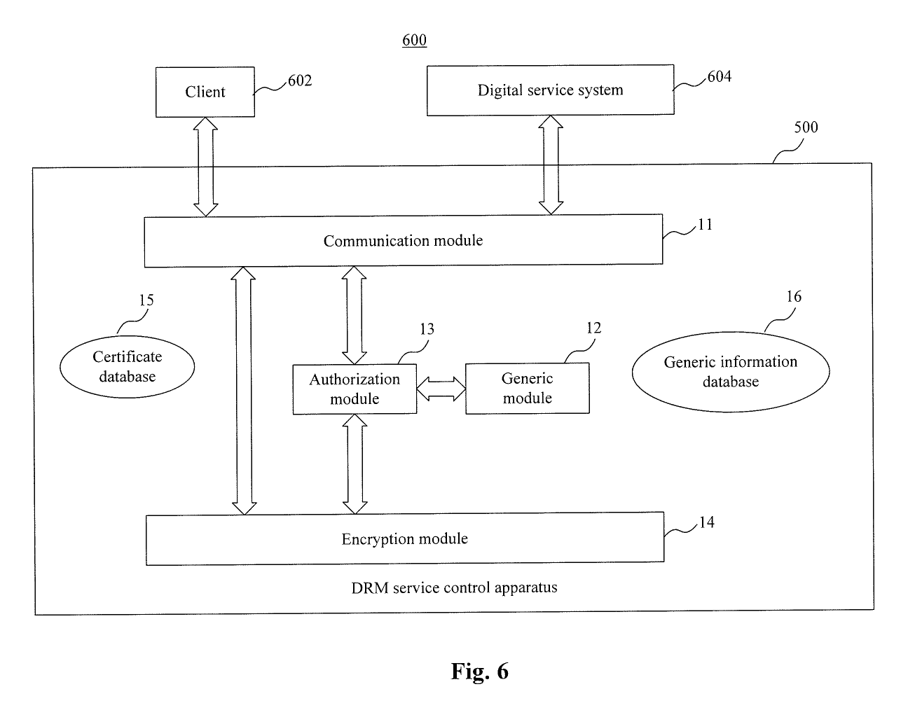

FIG. 6 shows a DRM service control system 600, according to an exemplary embodiment. Referring to FIG. 6, the system 600 may include the DRM service control apparatus 500 (FIG. 5), a client terminal 602, and a digital service system 604 such as an upper layer service system.

In exemplary embodiments, the DRM service control apparatus 500 may perform authorization control for a service provided from the digital service system 604, as described in FIG. 5.

In exemplary embodiments, the client terminal 602 may receive an authorization file transmitted from the DRM service control apparatus 500, determine whether digital resource feature information and rights feature information included in the received authorization file match, and perform a selected service operation when they match.

In exemplary embodiments, the DRM service control apparatus 500 may further be configured to include feature information of the authorization file, feature information of a rights issuer, feature information of a rights obtainer, integrity information of the authorization file, and validity information of the authorization file in the authorization file to be transmitted.

In exemplary embodiments, the client terminal 602 may further be configured to determine whether the feature information of the authorization file, the feature information of the rights issuer, the feature information of the rights obtainer, the integrity information of the authorization file, and the validity information of the authorization file match, and performs the selected service operation when they match.

In exemplary embodiments, the communication module 11 of the DRM service control apparatus 500 in the system may interact with the client terminal 602 and the digital service system 604 for communication and data transport. The generic module 12 may obtain various authorization file templates in a generic information database, generate and manage respective generic features and set a currently activated item, generate corresponding authorization file templates for the generic features and then store and manage the file templates, and finally provide the authorization module 13 with a valid authorization file template. The authorization module 13 may be configured for generating, distributing, and managing authorization files of digital contents. The encryption module 14 may belong to a technical support layer and provide the DRM service control apparatus 500 with secured services.

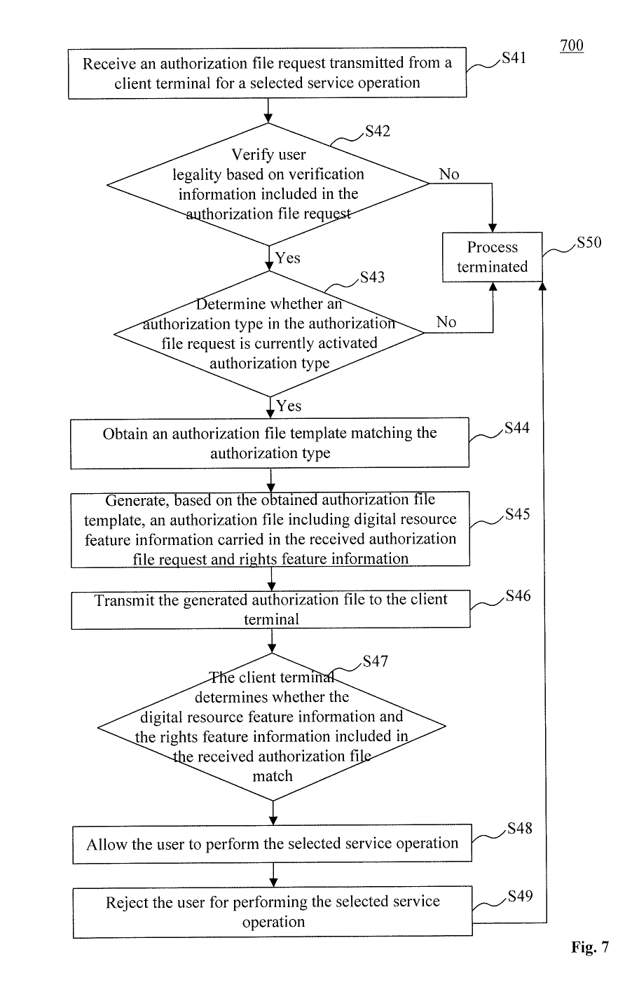

FIG. 7 shows a flowchart of a DRM service control process 700, according to an exemplary embodiment. Referring to FIG. 7, the process 700 may include the following steps.

In step S41, an authorization file request transmitted from a client terminal for a selected service operation may be received, similar to step S11 in FIG. 2.

In step S42, a user transmitting the authorization file request may be verified for legality against verification information included in the authorization file request. If the verification is not passed, the process may be terminated in step S50.

After the verification is passed, in step S43, it may be determined whether an authorization type included in the received authorization file request is a currently activated authorization type. If the verification is not passed, the process may be terminated in step S50.

If the determination is positive, in step S44, the authorization file template matching the authorization type included in the received authorization file request may be obtained.

In step S45, an authorization file may be generated based on the obtained authorization file template and rights feature information, the authorization file including digital resource feature information included in the received authorization file request and the rights feature information.

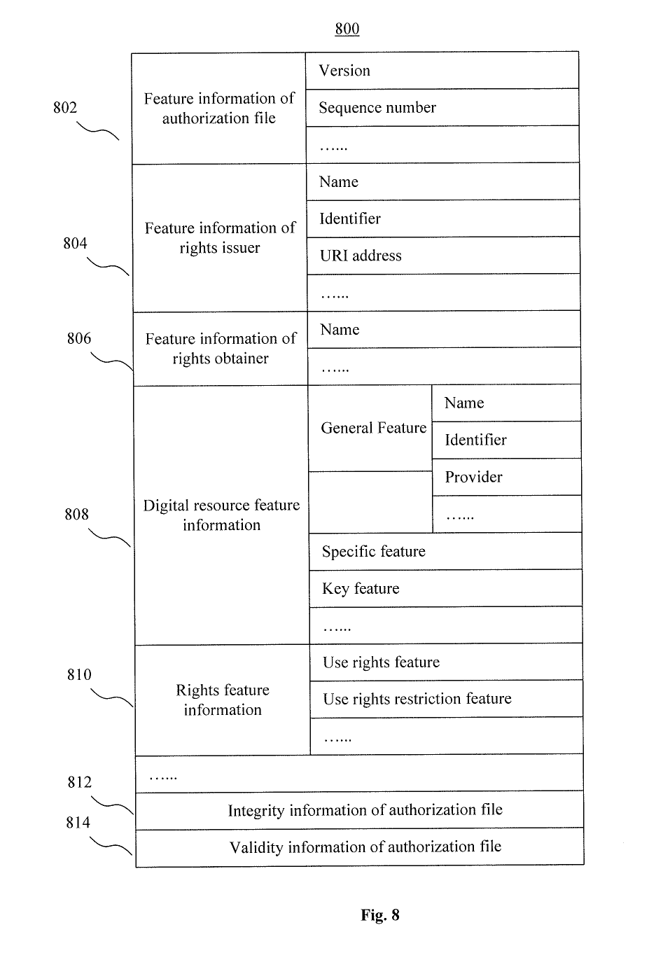

FIG. 8 shows an authorization file template 800, according to an exemplary embodiment. Referring to FIG. 8, the authorization file template 800 may include feature information 802 of an authorization file, feature information 804 of a rights issuer, feature information 806 of a rights obtainer, digital resource feature information 808, rights feature information integrity information 810 of the authorization file, and validity information 812 of the authorization file. The feature information 802 of the authorization file may include a version number, a sequence number, etc., or any combination thereof. The feature information 804 of a rights issuer may include a name, an identifier, a URI address, etc., or any combination thereof. The feature information 806 of a rights obtainer may include a name, an identifier, etc., or any combination thereof. The digital resource feature information 808 may include a general feature, a specific feature, a key feature, etc., or any combination thereof, where the general feature may include a name, an identifier, a provider, etc. The rights feature information 810 may include a use rights feature, a use rights restriction feature, etc., or any combination thereof. The integrity information 812 of the authorization file is to ensure integrity of the foregoing features, and validity information 814 of the authorization file is relevant information to verify the authorization file for validity.

Referring back to FIG. 7, in step S46, the generated authorization file may be transmitted to the client terminal.

In step S47, the client terminal may determine whether the digital resource feature information and the rights feature information included in the received authorization file match and performs step S48 when they match. For example, the client terminal may parse the authorization file for a key in the digital resource feature information and determine by verifying the key whether to allow the operation of the user.

In step S48, the user may be allowed to perform the selected service operation. For example, the user is allowed to perform the service operation specified by the use rights feature and the use rights restriction feature included in the rights feature information.

Otherwise, in step S49, the user may be rejected to perform the selected service operation. For example, the user may be prompted of inaccessibility or a verification information error.

In step S50, the process may be terminated. The process may be terminated because the legality verification is not passed or because no corresponding authorization file template is available. At this time, the user may be prompted of the termination reason.

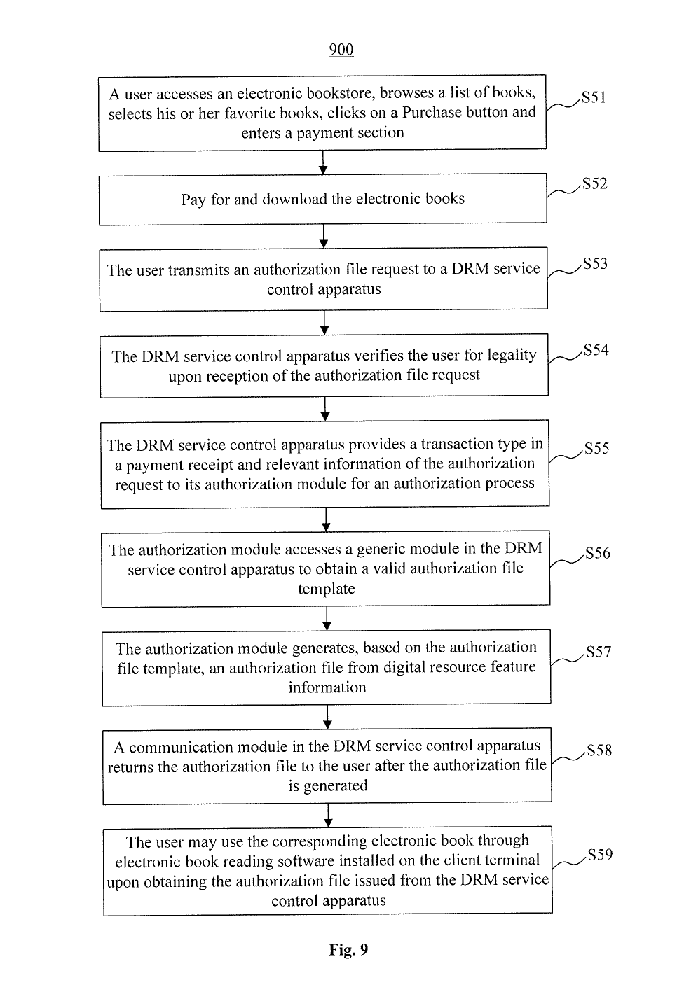

FIG. 9 shows a flowchart of a DRM service control process 900, according to an exemplary embodiment. Referring to FIG. 9, the exemplary authorization process 900 of an electronic book and may include the following steps.

In step S51, a user may access an electronic bookstore, browse a list of books, select his or her favorite books, click on a Purchase button, and enter a payment section.

In step S52, the selected electronic books may be paid for and downloaded.

For example, in the payment section, the user may enter his or her own payment account number to purchase the books selected in the step S51. Upon successful payment, the user may click on a “Download” button to download the books. It may then enter the processes of requesting, generating, and distributing an authorization file upon successful purchase and downloading of the electronic books.

In step S53, an authorization file request may be transmitted from the user to a DRM service control apparatus.

For example, upon obtaining each electronic book, the user may need to obtain an authorization file corresponding to the electronic book to open the electronic book for reading. The user may transmit the authorization file request to the DRM service control apparatus by encrypting and encapsulating a unique identifier of the electronic book, a payment receipt of purchasing the electronic book, and equipment information on a currently used device by a public key of the DRM service control apparatus and then transmitting a data packet to the DRM service control apparatus to request for authorization. A request type included in the authorization file request may be use authorization. The unique identifier of the electronic book, the payment receipt of purchasing the electronic book, and the equipment information on the currently used device may be digital resource feature information.

In step S54, the DRM service control apparatus may verify the user for legality upon reception of the authorization file request. For example, upon reception of the authorization request, the DRM service control apparatus may first verify the payment receipt of the electronic book. If there is no payment receipt or the payment receipt transmitted from the user is illegal, the DRM service control apparatus may reject service authorization, return relevant error information to the user, and ask the user to further request for authorization after payment.

If the verification is passed, in step S55, the DRM service control apparatus may provide a transaction type in the payment receipt and relevant information of the authorization request to its authorization module for an authorization process.

In step S56, the authorization module may accesse a generic module in the DRM service control apparatus to obtain a valid authorization file template. For example, the generic module may first determine, based on an authorization type, whether the current authorization request is legal, that is, whether the authorization type is a currently activated authorization type. If it is legal, then a currently activated authorization file template matching the authorization type may be returned to the authorization module; otherwise, relevant error information may be returned to the authorization module.

In step S57, the authorization module may generate, based on the authorization file template, an authorization file from the digital resource feature information, which may be the unique identifier of the electronic book or other information.

In step S58, a communication module in the DRM service control apparatus may return the authorization file to the user after the authorization file is generated.

In step S59, upon obtaining the authorization file issued from the DRM service control apparatus, the user may use the corresponding electronic book through electronic book reading software installed on the client terminal.

The process of using the electronic book generally may include the steps of recovering a key of the electronic book from the authorization file, decrypting the contents of the electronic book by the key, presenting the decrypted contents to a user interface, etc.

A set of use rights policies that may be provided in the above-described method may be modified dynamically in response to a change in service policy during operation of a system and be set flexibly for a specific application mode. A copyright protection demand may be accommodated for various digital resources in various service modes, and different authorization file templates may be generated and activated in different service modes. As a result, an authorization file for a desirable service mode may be generated correspondingly. If the set of rights policies of a user for the digital resources in the application system needs to be changed, it can be done by adding new generic features and corresponding authorization file templates dynamically without influencing the use of the user and without upgrading the application system.

If a plurality of service modes coexist in an application, a plurality of authorization file templates may be generated and activated concurrently, and a service mode may be matched. When the DRM service control apparatus receives the authorization request, the generic module may search for an authorization file template corresponding to a service mode provided from the user, and the authorization module may generate and return to the user an authorization file based on that template.

In the illustrated embodiments, a generic module is included in a DRM service control apparatus for generating and managing digital rights-related generic features. A user may add or manage a generic feature, for example, via a management interface provided by the generic module, and the generic module may generate a file template corresponding to the newly added generic feature and stores the newly added generic feature and the file template onto a server via a storage interface. The authorization file generation module may obtain currently activated generic feature items via, for example, the management interface of the generic module, and generate and return to a service system or a requesting client a specific authorization file in the corresponding authorization file template.

In the illustrated embodiments, a generic multi-mode DRM service control method is provided, in which an authorization file template may be matched against an authorization type. Further, an authorization file appropriate for the authorization type may be generated, a DRM service control apparatus may be customized, and a plurality of authorization file templates of the DRM service control apparatus may coexist, thus avoiding separate program development efforts for each authorization type of each service and enabling digital rights access control to be genetic to a plurality of services.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. A digital rights management service control method, comprising:
receiving an authorization file request transmitted from a client terminal for a selected service operation;
obtaining an authorization file template matching an authorization type included in the authorization file request;
generating, based on the obtained authorization file template, an authorization file including digital resource feature information included in the authorization file request and rights feature information; and
transmitting the generated authorization file to the client terminal.

2. The method according to claim 1, wherein obtaining the authorization file template comprises:
determining whether the authorization type included in the authorization file request is a currently activated authorization type; and
obtaining the authorization file template matching the authorization type if it is determined that the authorization type is a currently activated authorization type.

3. The method according to claim 2, wherein when there is more than one version of an authorization file template corresponding to the authorization type, the method further comprises:
determining whether version information included in the authorization type in the authorization file request matches version information of the obtained authorization file template matching the authorization type; and
generating the authorization file if it is determined that the version information included in the authorization type matches the version information of the obtained authorization file template.

4. The method according to claim 1, further comprising:
verifying user legality based on verification information included in the authorization file request, and
obtaining the authorization file template if the verification is passed.

5. The method according to any one of claim 1, further comprising:
determining, by the client terminal, whether the digital resource feature information and the rights feature information included in the authorization file match, and
allowing the selected service operation if the digital resource feature information and the rights feature information match.

6. The method according to claim 5, wherein the authorization file further includes feature information of the authorization file, feature information of a rights issuer, feature information of a rights obtainer, integrity information of the authorization file, and validity information of the authorization file.

7. The method according to claim 6, further comprising:
determining, by the client terminal, whether the feature information of the authorization file, the feature information of the rights issuer, the feature information of the rights obtainer, the integrity information of the authorization file, and the validity information of the authorization file match, and
allowing the selected service operation if all of the information matches.

8. A digital rights management service control apparatus, comprising:
a communication module configured to receive an authorization file request transmitted from a client terminal for a selected service operation and to transmit a generated authorization file to the client terminal;
a generic module configured to obtain an authorization file template matching an authorization type included in the authorization file request; and
an authorization module, coupled to the communication module and to the generic module, configured to generate, based on the obtained authorization file template, an authorization file including digital resource feature information in the authorization file request and rights feature information.

9. The apparatus according to claim 8, wherein the generic module is further configured to:
determine whether the authorization type included in the authorization file request is a currently activated authorization type; and
obtain the authorization file template matching the authorization type if the authorization type is a currently activated authorization type.

10. The apparatus according to claim 9, wherein the authorization module is further configured to:
when there is more than one version of an authorization file template configured by the generic module corresponding to the authorization type, determine whether version information included in the authorization type in the authorization file request matches version information of the authorization file template obtained by the generic module; and
generate the authorization file if the version information included in the authorization type matches the version information of the authorization file template.

11. The apparatus according to claim 9, wherein the authorization module is further configured to:
verify user legality based on verification information included in the authorization file request, and
instruct the generic module to obtain the authorization file template if the verification is passed.

12. A digital rights management service control system, comprising the digital rights management service control apparatus according to claim 8, a client terminal, and a digital service system, wherein:
the digital rights management service control apparatus performs authorization control on a service provided from the digital service system; and
the client terminal receives an authorization file transmitted from the digital rights management service control apparatus, determines whether digital resource feature information and rights feature information included in the received authorization file match, and allows a selected service operation if the digital resource feature information and the rights feature information match.

13. The system according to claim 12, wherein:
the digital rights management service control apparatus is further configured to include feature information of the authorization file, feature information of a rights issuer, feature information of a rights obtainer, integrity information of the authorization file, and validity information of the authorization file in the transmitted authorization file; and
the client terminal is further configured to determine whether the feature information of the authorization file, the feature information of the rights issuer, the feature information of the rights obtainer, the integrity information of the authorization file, and the validity information of the authorization file match, and to allow the selected service operation if all of the information matches.
